(19) United States
(12) Patent Application Publication
(10) Pub. No.: US 2012/0113448 A1
(43) Pub. Date: May 10, 2012

(54) IMAGE FORMING APPARATUS AND IMAGE FORMING METHOD

(75) Inventor: Shoei Moribe, Tokyo (JP)

(73) Assignee: CANON KABUSHIKI KAISHA, Tokyo (JP)

(21) Appl. No.: 13/379,766

(22) PCT Filed: May 18, 2010
(86) PCT No.: PCT/JP2010/003328

§ 371 Date: Dec. 21, 2011

(30) Foreign Application Priority Data
Jun. 23, 2009 (JP) 2009-149165
Dec. 10, 2009 (JP) 2009-280687

(51) Int. Cl. H04N 1/60

(52) U.S. Cl. 358/1.9

(57) ABSTRACT

An image forming apparatus and an image forming method for forming an image by using a plurality of color materials including pigment as a color material, by causing a plurality recording heads to perform a recording scan in a direction perpendicular to a conveyance direction of a recording medium to scan same image areas on the recording medium more than once. The recording heads are fitted with recording-element columns as many as kinds of color materials. Each recording-element column includes a plurality of recording elements arranged in a direction parallel with the conveyance direction of the recording medium. The image forming apparatus includes an input unit configured to input image data to display an image, a conversion unit configured to convert image data into dot data representing an image by a plurality of dots, and an allocation unit configured to allocate the recording elements to the dot data in each of recording scans. The allocation unit performs the allocation in such a manner that dots are concentrated in clusters of a predetermined size in the same image areas and at least one dot is superposed on top of another.

### TECHNICAL FIELD

The present invention relates to an image forming apparatus and an image forming method for forming an image by a plurality of scannings.

### BACKGROUND ART

Reproduction and display of multi-gradation image data read by an image input device, such as a scanner, or multi-gradation graphic image data calculated by a computer are performed for various purposes. The reproduction and display of this kind is carried out by image output apparatuses, such as a display, a printer, a facsimile, or a digital copying machine. The amount of data is often reduced when multi-gradation image data is stored in the image output apparatuses or when data is transferred. In this case, gradation conversion is performed to reduce gradation values of each pixel. As a method for gradation conversion processing, an error diffusion method or an almost equivalent method termed an average error minimization is used to realize a desirable image quality.

In inkjet printers, a multi-pass recording method has been adopted. The multi-pass recording method is a recording method in which for any given area of a single image, ink dots constituting the image of that area are divided into groups of small numbers and formed by a plurality of scannings. According to this method, for example, density irregularity, caused by variation in discharge performance such as variation of the ink discharge direction of each ink discharge nozzle (or discharge port) and/or by error in conveyance of recording paper, can be diffused in a plurality of scanning passes. As a result, an image of high quality with reduced density irregularity can be recorded (Japanese Patent Application Laid-Open No. 2002-144552).

To form ink dots constituting a recoded image by dividing the ink dots into groups of small numbers by a plurality of scannings, recording elements are assigned to different scannings, generally, by a mask processing using mask patterns (referred to simply as masks). A mask pattern is formed by arranging recordable pixels and non-recordable pixels in a specified area. A method can be formulated to meet various purposes, such as finding a better way of arranging the recordable pixels in mask patterns, adjusting numbers of dots to be recorded in a plurality of scannings, or eliminating density irregularity, and so on (Japanese Patent Application Laid-Open No, 2006-44258).

Generally, in a method of gradation conversion processing and in a multi-pass recording method, in order to reduce a feeling of granularity on printed products, dots are arranged to approximate an ideal form in which space frequency includes lots of high frequency components. In addition, the dots are arranged not to be biased to reduce density irregularity, in pursuit of an ideal arrangement.

In conventional design principles, however, under any conventional design policies, it is impossible to prevent coloring of specularly reflected light (hereafter sometimes referred to as “interference color”). As illustrated in FIG. 11, an interference color is a phenomenon of coloring of reflected light which occurs because specific wavelengths are strengthened or weakened due to a shift in a phase of light based on an optical path difference delta.

It is known that since this phenomenon occurs only in a case where a printed product has a sufficiently smooth surface, if an ink is used which shows a rough surface in a printed product, the above-mentioned coloring problem does not arise. However, when an ink with this characteristic is used, the sharpness of the gloss of a whole printed matter is reduced.

### CITATION LIST

### Patent Literature

PTL 1: Japanese Patent Application Laid-Open No. 2002-144552
PTL 2: Japanese Patent Application Laid-Open No, 2006-44258

### SUMMARY OF INVENTION

The present invention is directed to providing an image forming apparatus and an image forming method capable of decreasing interference color while maintaining the sharpness of gloss.

According to an aspect of the present invention, an image forming apparatus forms an image by using a plurality of color materials including pigment as a color material, by scanning and recording with a plurality of recording heads in a direction perpendicular to a conveyance direction of a recording medium to scan same image areas on the recording medium more than once. The recording head are fitted with recording-element columns as many as kinds of color materials, each recording-element column including a plurality of recording elements arranged in a direction parallel with the conveyance direction of the recording medium. The image forming apparatus includes an input unit configured to input image data to display an image, a conversion unit configured to convert the image data into dot data representing an image by a plurality of dots, an allocation unit configured to allocate the recording elements to the dot data among in each of recording scans, wherein the allocation unit performs the allocation in such a manner that the dots are concentrated in clusters of a predetermined size in the same image areas and at least one dot is superposed on top of the other.

Further features of the present invention will be apparent from the following description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a composition of an image forming system.

FIG. 2 is a block diagram illustrating main functional structures of a PC and a printer.

FIG. 3 is a schematic diagram of examples of mask patterns.

FIG. 4A is a schematic diagram for comparison of mask patterns.

FIG. 4B is a schematic diagram for comparison of mask patterns.

FIG. 5 is a schematic diagram illustrating an example of binary image data B(x, y) of a size of 6*6 pixels.

FIG. 6A is a schematic diagram illustrating transitions of dots.

FIG. 6B is a schematic diagram illustrating transitions of dots.

FIG. 6C is a schematic diagram illustrating transitions of dots.

FIG. 6D is a schematic diagram illustrating transitions of dots.

FIG. 6E is a schematic diagram illustrating transitions of dots.

FIG. 6F is a schematic diagram illustrating transitions of dots.

FIG. 7A is a schematic diagram illustrating results of multi-pass recording in a first exemplary embodiment.

FIG. 7B is a schematic diagram illustrating results of multi-pass recording in a first exemplary embodiment.

FIG. 7C is a schematic diagram illustrating results of multi-pass recording in a first exemplary embodiment.

FIG. 7D is a schematic diagram illustrating results of multi-pass recording in a first exemplary embodiment.

FIG. 7E is a schematic diagram illustrating results of multi-pass recording in a first exemplary embodiment.

FIG. 7F is a schematic diagram illustrating results of multi-pass recording in a first exemplary embodiment.

FIG. 8 is a diagram illustrating an example of error diffusion coefficients.

FIG. 9 is a graph illustrating results of experiment with interference color.

FIG. 10 is a graph illustrating results of experiment with gloss sharpness.

FIG. 11 is a schematic diagram illustrating a mechanism of occurrence of interference color.

FIG. 12 is a diagram illustrating an example of dot patterns.

### DESCRIPTION OF EMBODIMENTS

The accompanying drawings, which are incorporated in and constitute a part of the specification, illustrate exemplary embodiments, features, and aspects of the invention and, together with the description, serve to explain the principles of the invention. It should be noted that the relative arrangement of the components, the numerical expressions and numerical values set forth in these embodiments do not limit the scope of the present invention unless it is specifically stated otherwise.

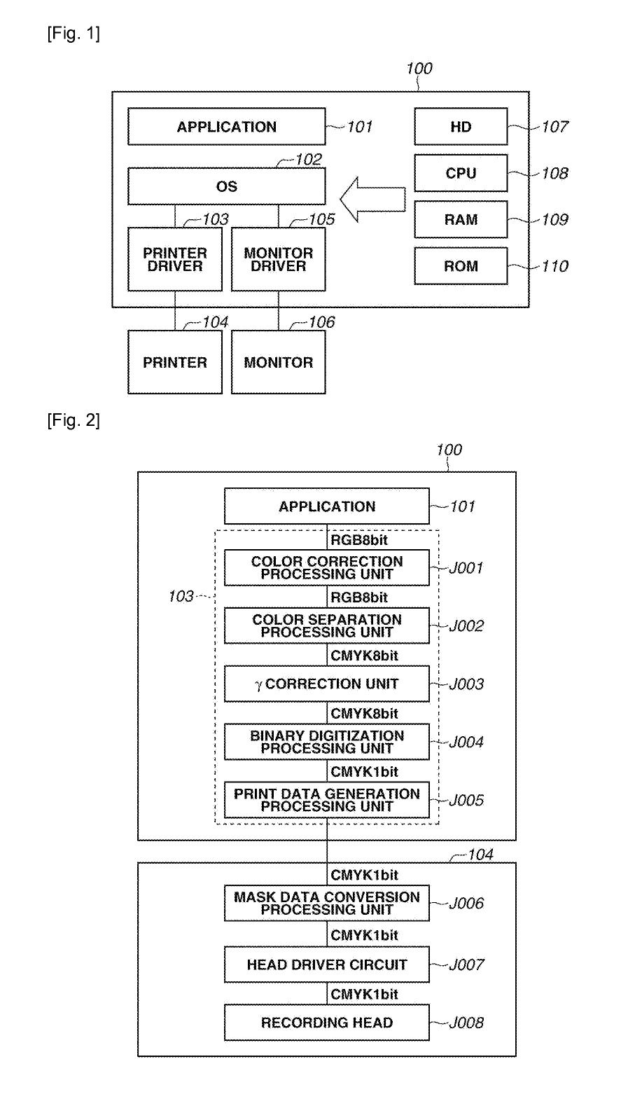

A first exemplary embodiment of the present invention is described. FIG. 1 is a block diagram of composition of an image forming system, including an image forming apparatus according to a first exemplary embodiment of the present invention. The image forming system includes a printer (image forming apparatus) 104, such as an inkjet printer, a personal computer (PC) 100 to supply the printer 104 with image data, and a monitor 106 to display image data which is output by the PC 100.

The PC 100 includes hardware, such as a hard disk (HD) 107, a central processing unit (CPU) 108, a random access memory (RAM) 109, and a read only memory (ROM) 110. For example, the HD 107 or the ROM 110 stores an operating system (OS) 102, application software 101, a printer driver 103, and a monitor driver 105.

The application software 101 performs the processing for a word processor, spreadsheet, and/or an Internet browser. The monitor driver 105 performs the processing such as generating image data to be displayed on the monitor 106. The printer driver 103 performs drawing processing according to various drawing instructions issued from the application software 101 to the OS 102 (such as image drawing instruction, a text character drawing instruction, graphic drawing instruction), and generates binary image data to be used in the printer 104. The printer driver 103 executes a predetermined image processing to generate binary image data for each of a plurality of ink colors used in the printer 104, detail of which will be described later.

The CPU 108 executes the processing based on software stored in the HD 107 or the ROM 110, and uses the RAM 109 as a work area during execution of processing. The CPU 100 serves as a host computer and uses the operating system (OS) 102 to operate software, including the application software 101, the printer driver 103, and the monitor driver 105.

The printer 104 is, for example, a so-called serial printer that scans a recording head on a recording medium to discharge ink during scanning to record ink dots. Recording heads of different colors corresponding to C (cyan), M (magenta), Y (yellow), and K (black) inks are mounted on a carriage of the printer 104. Simultaneously with the carriage's scanning of a recording medium, such as recording paper, the recording heads scan the recording medium. Nozzles of each recording head have an array density of 1200 dpi, for example, and an ink droplet of 3 pico-liters is discharged from each nozzle. The number of nozzles of each recording head is 768, for example.

The printer 104 includes a memory, and mask patterns determined for each scan and different color are stored in the memory. The printer 104 forms an image while generating or after generating binary divided image data by using the mask patterns. Therefore, the printer 104 is capable of executing multi-pass recording.

FIG. 2 is a functional block diagram illustrating main functions of the PC 100 and the printer 104 for generating images by the printer 104.

The application software 101 of the PC 100 is configured to enable a user to generate image data to form an image by the printer 104. When an image is formed, image data generated by the application software 101 is delivered to the printer driver 103.

The printer driver 103 functions as a color correction processing unit J001, a color separation processing unit J002, a correction unit J003, a binary digitization processing unit J004, and a print data generation processing unit J005. The color correction processing unit J001 performs color gamut conversion to convert a color gamut of the monitor 106, which displays image data generated by the application software 101, into a color gamut of the printer 104. More specifically, image data, in which R (red), G (green), and B (blue) are each expressed by 8 bits, are converted into 8-bit data R, G, and B in the color gamut of the printer 104 according to a three-dimensional look-up table (LUT).

The color separation processing unit J002 separates the colors reproducing the color gamut converted by the color correction processing unit J001, into ink colors. In other words, the color separation processing unit J002 performs processing to provide 8-bit data of C, M, Y, and B corresponding to a combination of inks to reproduce colors by 8-bit data R, G, and B obtained by the color correction processing unit J001.

The gamma correction unit J003 performs gamma correction to each of data of C, M, Y, and K obtained by the color separation processing unit J002. To be more precise, by using the color separation processing unit J002, data of C, M, Y, and K are separated and associated linearly with gradation characteristics of the printer 104. The binary digitization processing unit J004 performs a gradation conversion processing to convert gamma-corrected 8-bit data of C, M, Y, and K into 1-bit data of C, M, Y, and K. In other words, the binary digitization processing unit J004 serves as a quantization unit to quantize 8-bit data into binary data by reducing the gradation. In this processing, signals after the quantization are concentrated spatially. The print data generation processing unit J005 generates print data by adding print control data, for example, to binary image data including binary-digitized 1-bit data of C, M, Y, and K. The binary image data includes dot-record data to specify dot-record, and non-dot record data to specify non-record of dot. The print control data includes recoding medium information, record quality information, and control information such as paper feeding method.

Print data, generated in a series of processing performed by the color correction processing unit J001, color separation processing unit J002, correction unit J003, binary digitization processing unit J004, and the print data generation processing unit J005, is supplied to the printer 104.

The printer 104 serves as a mask data conversion processing unit J006 to perform a mask data conversion processing on binary image data included in input print data. The mask data conversion processing unit J006 performs a logical AND operation between input binary image data and mask patterns stored in a specified memory in the printer 104. As a result, divided binary image data (dot data) is generated which is used in each scan in multi-pass recording. In addition, timing at which ink is discharged is determined. The divided binary image data includes dot-record data and non-dot-record data as described above.

The printer 104 includes four recording heads J008 to discharge inks of four different colors. The printer 104 includes a head drive circuit J007, which causes the recording heads to discharge ink at specified timing based on divided binary image data. When a main scan is completed by a head mounted with the recording heads and ink tanks to record ink dots of C, Y, M, and K colors, the recording medium is conveyed by a predetermined distance in a sub scanning direction (in a direction perpendicular to the main scanning direction). As a main scan and a sub scan are repeated alternately, an image is formed gradually.

Mask patterns (pass masks) used in the first embodiment are described. In the first embodiment, signals after the quantization are concentrated spatially. In other words, mask patterns intended to “gather the dots in clusters” and to “overlay one dot on another” are used. As described above, those mask patterns are stored previously in a predetermined memory, and the mask data conversion processing unit J006, when it performs a mask data conversion processing, uses those mask patterns.

The mask data conversion processing unit J006 controls recording elements to record dots and a recording sequence functioning as a conversion unit or an allocation unit applying a mask pattern M(i, j) in multi-pass recording to binary image data B(x, y). The coordinates (x, y) indicate a pixel position of an image, and binary image data B(x, y) indicates a density value at the pixel position (x, y). In other words, in a binary type inkjet printer, B(x, y)=1 means a black dot (dot ON), and B(x, y)=0 means a white dot (dot OFF).

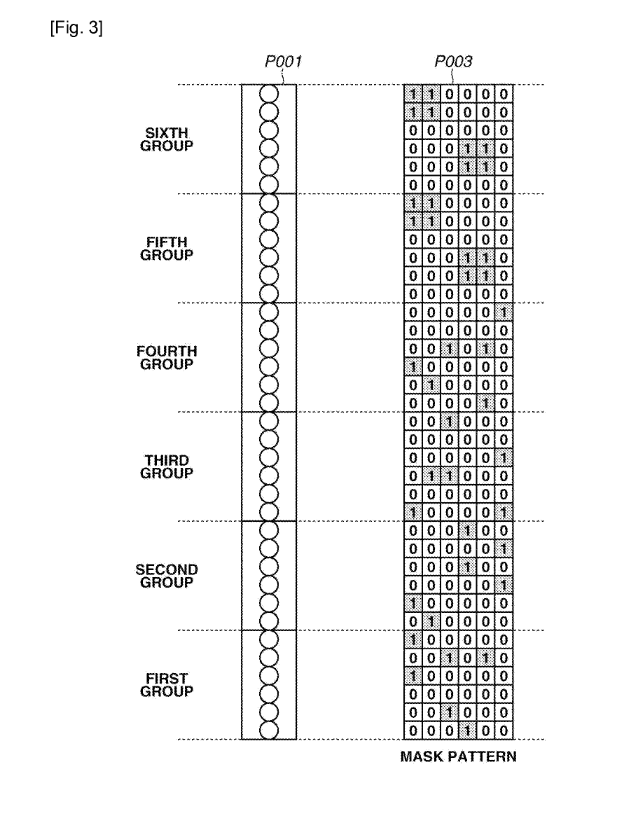

FIG. 3 is a schematic diagram illustrating mask patterns by way of an example. In this example, the number of times of multi-pass recording is 6 times. The number of nozzles of the recording head P001 is 36. The nozzles are divided into the first group to the sixth group, and each group includes 6 nozzles. Each group corresponds to image formation by one main scan. The structure of the recording head is common to colors C, M, Y, and K. The recording head P001 corresponds to one of the recording heads of the four colors. The size of binary image data B(x, y) is 6*6 pixels. The mask patterns P003 is set associated with the nozzle columns of the respective groups. In each of mask patterns P003, the recordable pixels are indicated by 1 (on black background), and the non-recordable pixels are indicated by 0 (on white background).

In this embodiment, as illustrated in FIG. 3, in the first to fourth groups, mask patterns with high dot dispersiveness are set, and in the fifth and sixth groups, mask patterns with the dots concentrated in the 2*2 pixel areas are set. Therefore, up to the fourth pass, the dots are recorded in such a manner that the dot dispersiveness is high, in the fifth pass, the dots are recorded concentrated in the 2*2 pixel areas, and in the sixth pass, in a similar fashion, the dots are concentrated in the 2*2 pixel areas.

A difference between the mask patterns P003 in this embodiment and the conventional mask patterns is described as follows.

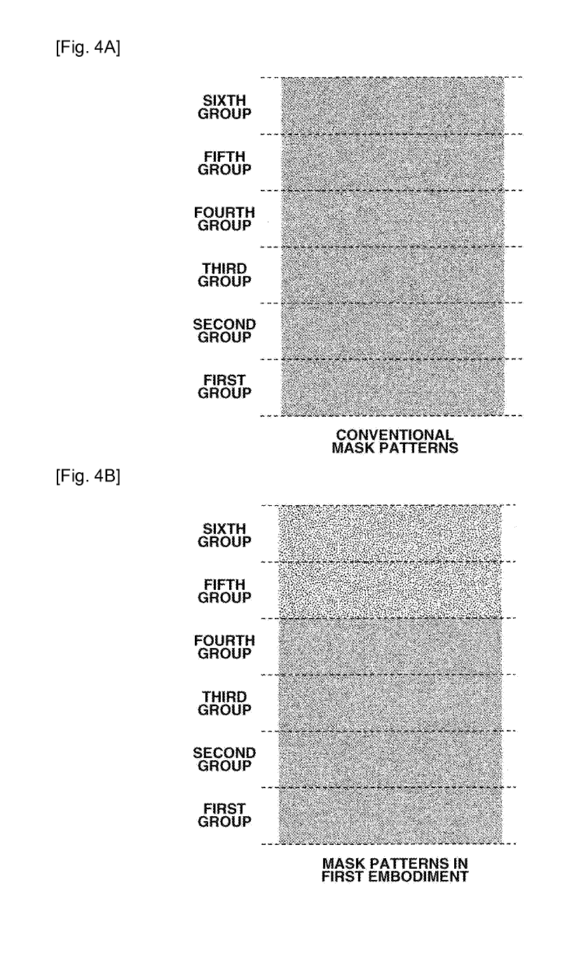

FIG. 4A illustrates a conventional mask pattern by way of an example, and FIG. 4B illustrates mask patterns P003 according to this embodiment. In both examples, the mask pattern is divided equally into 6 areas arranged in a vertical direction, and the number of vertical-direction pixels of each area is equal to the number of nozzles corresponding to the area, in the recording head of the inkjet printer. How the recording elements are to be allocated is determined for each scanning pass by black dots in each area. In other words, in recording in each pass, dots to be output are determined by calculating a logical AND between a mask pattern area (the lowest area of the 6 areas in the first pass, for example) and binary image B(x, y).

As it is obvious from a comparison between FIG. 4A and FIG. 4B, however, though in the conventional mask pattern, mask patterns are almost the same among different passes, in the mask patterns P003, in the fifth and sixth groups corresponding to the fifth and sixth passes, the dots are concentrated in clusters of a specified size. Further, in the mask patterns P003, the mask patterns are the same in the fifth and sixth groups. However, the mask patterns need not be perfectly the same between the fifth and sixth groups, but the dots have only to be recorded in the same positions in a fixed percentage. Further, groups, which have the same mask pattern with the dots formed in clusters of a predetermined size, can be any groups. In this regard, the inventors in the present patent application have found that the effect is maximized if the groups corresponding to passes in a latter half of recording (in the fifth and sixth passes in a case of 6-pass recording) have the same mask pattern.

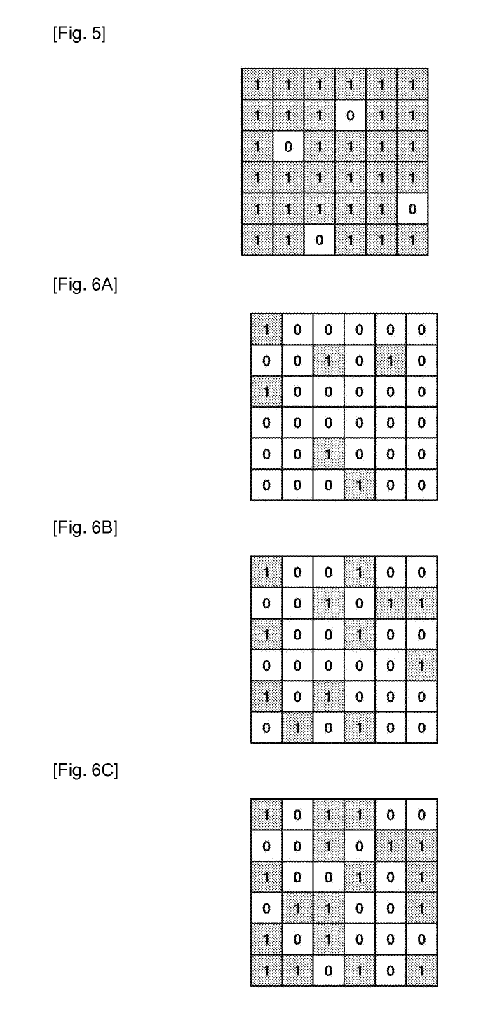

Next, a mask data conversion processing using the mask patterns P003 is described. FIG. 5 is a schematic diagram illustrating an example of binary image data B(x, y) in a size of 6*6 pixels. In a mask data conversion processing, a logical AND is calculated between a mask pattern M(i, j) of each group of the mask patterns P003 and binary image data B(x, y), and results are accumulated.

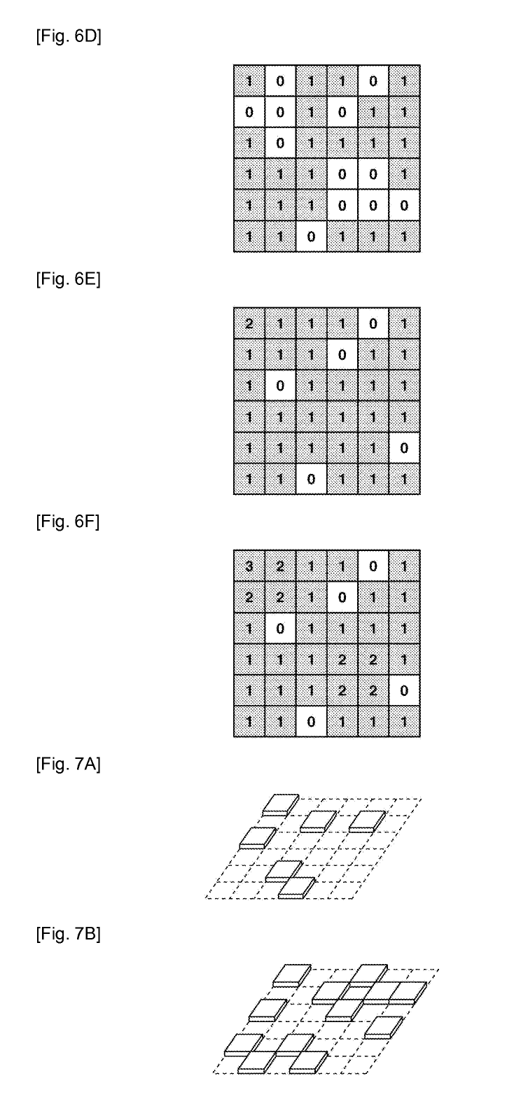

In a first pass, a logical AND is calculated between a mask pattern M(i, j) of the first group and binary image data B(x, y) and dots are arranged as illustrated in FIG. 6A. In a second pass, a logical AND is calculated between a mask pattern M(i, j) of the second group and binary image data B(x, y), and a result is added to the dots of FIG. 6A, a result of which is the dots illustrated in FIG. 6B. This processing is repeated and the dots come to be arranged as illustrated in FIGS. 6C, 6D, 6E, and 6F. FIG. 6 indicates 1 when 1 dot is arranged in a pixel, indicates 2 when 2 dots are arranged in a pixel, and indicates 3 when 3 dots are arranged in a pixel. When results of the logical ANDs between binary image data B(x, y) and a mask pattern M(i, j) are added serially, an image is formed as illustrated in FIG. 6F.

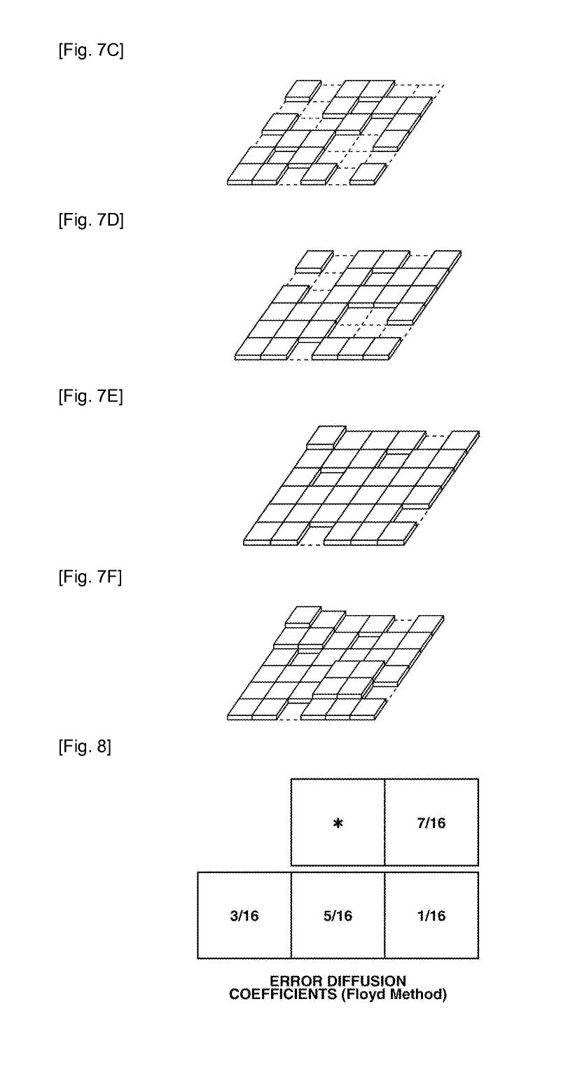

FIGS. 7A to 7F are schematic diagrams illustrating results of multi-pass recording described above, and indicate how the dots in FIG. 6F were laid out in three-dimensional views. As illustrated in FIGS. 7A to 7F, according to the first embodiment, minute ups and downs are formed on the surface of a printed matter even if a kind of ink which makes a rough surface on a printed paper is not used. Therefore, optical path differences are produced so that interference colors can be suppressed. In fact, it is difficult to form dots in rectangular parallelepiped as illustrated, but this is not necessary. Even if the dots are cylindrical in shape, the advantages of the first embodiment are not lost, and the shape of printing dots is not limited.

A method for designing the mask patterns P003 (pass masks) is described. Here, a method for generating the mask pattern M(i, j) is described, which is based on a mask pattern design technology using a concept of repulsive potential. The mask pattern design technology using a concept of repulsive potential is well known. For example, Japanese Patent Application Laid-Open Nos. 2002-144552 and 2006-44258 discuss this technology.

A cluster size and which passes are to be superposed are first determined. In this embodiment, a cluster size of 2*2 pixels is used and the fifth and sixth passes are superposed. Then, only mask patterns in the fifth pass are designed using repulsive potential. At this time, a restriction is imposed such that generated dots are concentrated in clusters of 2*2 pixels. In order to set the restriction, a mask pattern may be designed by regarding pixels in an area of 2*2 pixels as one pixel, for example. Then, for a mask pattern in the sixth pass, the same mask pattern as in the fifth pass is designed. However, the mask pattern for the sixth pass need not be perfectly identical with the one described above, but the mask pattern has only to be designed so that dots are recorded in the same positions in a certain proportion.

Subsequently, mask patterns in the first to fourth passes are generated based on the mask pattern design technology using a concept of repulsive potential discussed in Japanese Patent Application Laid-Open Nos. 2002-144552 and 2006-44258, for example. At this time, the mask patterns should preferably be designed taking into consideration the repulsive potential already generated in the first and sixth passes. By the method described above, a mask pattern M(i, j) of the respective groups in the first embodiment can be designed. Though a technology which uses repulsive potential has been described as the basic mask pattern design technology, so long as the dots can be clustered in predetermined groups, the mask pattern design technology is not limited to a specific technology.

The pass masks generated as described have been applied to the pass masks of all four colors in this embodiment. However, it is more preferable to selectively apply these pass masks according to a type of ink on an ink-by-ink basis. In particular, these pass masks are preferably selectively applied to low density ink, such as yellow ink, light ink (such as light cyan, light magenta, and light gray), and clear ink.

This is because low density ink is more likely to produce an interference color than high density ink. Another reason is that deterioration of a feeling of granularity due to the clustering of the dots is at a low level. The pass masks generated as described may be selectively applied according to an output mode. For example, these pass masks can be applied when the user selects an interference color reduction priority mode to give high priority to reduction of interference color as an output mode. In addition, the application of the pass masks may be automatically selected according to a type of image to be output (photo or document, for example) or according to a type of paper. In this embodiment, a case where four colors of ink are used has been described. However, more than four ink colors may be used. Or, three or less colors of ink may be used. In other words, the number of ink colors is not limited to four.

In this embodiment, color printing has been described, but this embodiment may also be applied to monochrome printing, in which this embodiment is preferably be applied to a light gray ink. In this embodiment, the number of scannings of multi-pass recording has been 6 passes, but the scannings are not limited to 6 passes. The binary data need not be binary, and the number of gradation is not limited. The mask patterns P0003 may be stored in a predetermined memory, and the PC 100 may function as a data processing apparatus to generate data. In this case, the PC 100 generates the mask patterns P003 (pass masks), and the generated mask patterns P003 are stored in a predetermined memory in the printer 104.

A second embodiment of the present invention is described below. In the first embodiment, since some dots are formed in the same positions in a mask pattern M(i, j), there is a possibility that the density preservation quality of a whole image becomes a problem. In this regard, in the second embodiment, by taking corrective measures for the mask pattern M(i, j) during gradation conversion, a problem is prevented from arising. Therefore, the operation of the binary digitization processing unit J004 is different from the first embodiment. Other structures and operations are similar to those in the first embodiment.

Also in this embodiment, the binary digitization processing unit J004 generates binary image data B(x, y). As described above, binary image data B(x, y) indicates a density value of a pixel position (x, y). In this embodiment, corrective measures are applied during gradation conversion by referring to a mask pattern M(i, j) generated in a similar way as in the first embodiment and stored in a predetermined memory of the printer 104. Correction processing for quantization errors, which occur when an error diffusion method is used as a gradation conversion method, is described in the following.

In an ordinary binary error diffusion method, by using equations (1) and (2), binary output image B(x, y) is determined.

$$\{ \begin{matrix}B ( x , y ) = 1 & ( if I ( x , y ) + D ( x , y ) > T ( x , y ) ) \\ B ( x , y ) = 0 & ( else )\end{matrix} \qquad [ Math . 1 ]$$

E(x,y)=I(x,y)+D(x,y)−O(x,y) [Math.2]

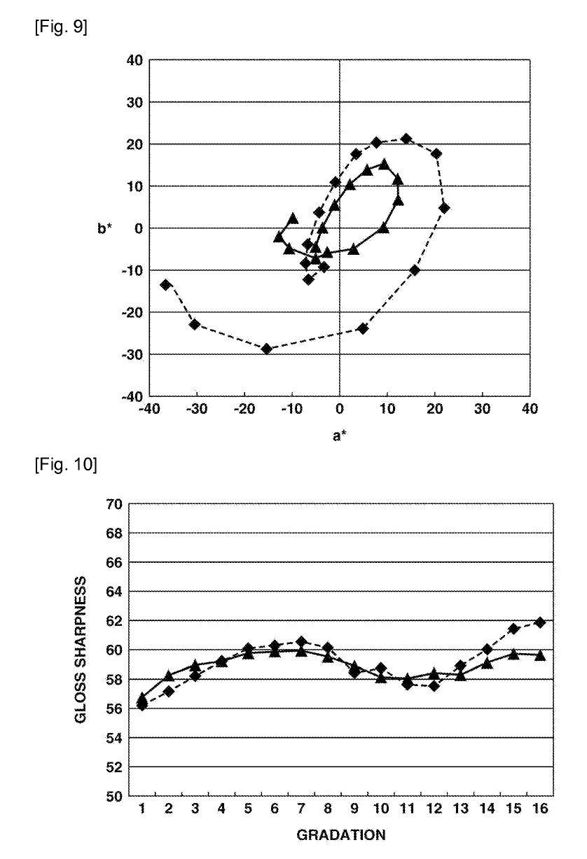

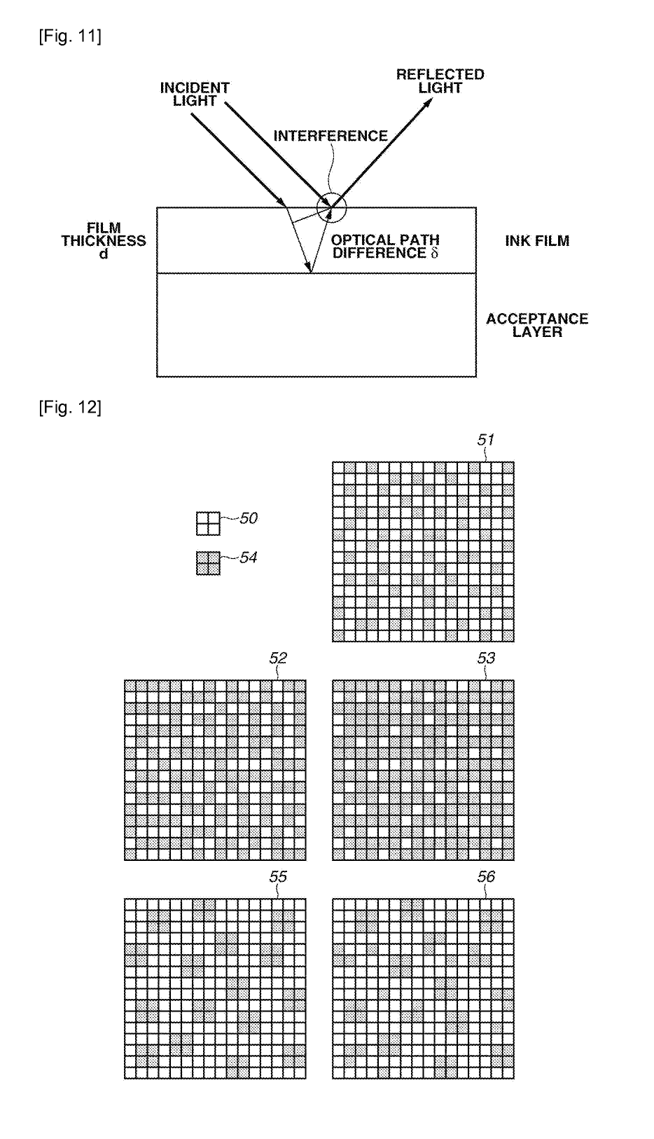

I(x, y) is a density value of an input image prior to gradation conversion, T(x, y) is an arbitrary threshold value, and D(x, y) is a diffused error integration value due to diffusion of error E(x, y) defined by equation (2), to the adjacent pixels. A proportion of error diffusion is determined by an error diffusion coefficient illustrated in FIG. 8. If a diffusion coefficient in FIG. 8 is applied, it follows that an arbitrary pixel receives all of the diffused error from the adjacent pixels (except at the edges of the image). Therefore, in the second embodiment, equation (3) is used instead of equation (1).

$$\{ \begin{matrix}B ( x , y ) = c & ( if I ( x , y ) + D ( x , y ) > T ( x , y ) ) \\ B ( x , y ) = 0 & ( else )\end{matrix} \qquad [ Math . 3 ]$$

Letter c indicates a number of ON dots in each pass which correspond to a pixel positions (x, y) in a mask pattern M(i, j). Similar to a case where B(x, y)=1, when B(x, y) is more than or equal to 2, the dot is a black dot (dot ON). When B(x, y) is more than or equal to 2, however, a value of error E(x, y) calculated by equation (2) is affected. By using equation (3), gradation conversion can be performed while the density of the whole image can be preserved. For example, even if some dots invariably is turned OFF by a mask pattern M(i, j), the density value after gradation conversion can be made 0, and the error can be diffused around the pixel.

As described above, in the second embodiment, the density is preserved in “halftone” considering “dot on dot” of mask patterns, and when binary image data B(x, y) is generated, quantization errors are corrected to suit the mask patterns. Therefore, not only the effects similar to the first embodiment can be obtained, but also a problem of density preservation quality of the whole image can be avoided.

Experiment results has revealed that the interference color was reduced in the second embodiment as follows. In a first experiment, a certain gradation patch was printed, and spectral characteristics of specular reflected light expressed in Lab* values were obtained. FIG. 9 is a graphical representation of the experiment results. In FIG. 9, a broken line with a blacked-out square sign indicates the results of conventional mask patterns, and a slid line with a blacked-out triangle sign indicates results obtained when the mask pattern M(i, j) in the second embodiment were used.

As illustrated in FIG. 9, when the mask pattern M(i, j) according to the second embodiment was used, the a*b* value of a specular reflected light came closer to 0 compared with a case where the conventional mask pattern was used. This means that the interference color was suppressed. This effect indicates, like in the first embodiment, that since minute ups and downs were formed on the surface configuration of a printed product, the optical path difference varied so that the effects of interference were weakened.

In the second experiment, the gloss sharpness of same gradation patches was evaluated, results of which are illustrated in FIG. 10. Like in FIG. 9, in FIG. 10, a broken line with a blacked-out square sign indicates the results of conventional mask patterns, and a slid line with a blacked-out triangle sign indicates results obtained when the mask pattern M(i, j) in the second embodiment were used.

As illustrated in FIG. 10, the gloss sharpness when the mask pattern M(i, j) in the second embodiment is used is at a level equal to the gloss sharpness obtained with the conventional mask pattern, so that the gloss sharpness could be prevented from lowering. This is because there was hardly any change in the normal vector distribution in the surface configuration. In the gloss sharpness evaluation value used in this evaluation, a difference of about 2.0 is so small that it cannot be perceived subjectively.

Since the increase in density when dots are recorded in the same positions twice or more is ordinarily non-linear, it is preferable to perform non-linear correction on the equation (3). In the second embodiment, a binary error diffusion method is adopted as the gradation conversion method, but the gradation conversion method is not limited to this method.

A third embodiment of the present invention is described below. In the first embodiment, the processing is performed focusing on a dot concentration property, that is, a degree of dot concentration by pass masks. Also in half-toning, it is desirable to control the concentration of the dots. In half-toning, the dot concentration should preferably be changed selectively according to gradation of an input image. Its reason can be seen from the results illustrated by the broken line and the solid line in FIG. 9. The intensity of the interference color is indicated by a distance from the origin of the graph. The graph moves towards the right side and moves upwards (See changes in the lower middle side to the right side in FIG. 9) far away from the origin, and once comes closer to the origin (in the lower right side in FIG. 9), and again moves far away from the origin (in the lower left side in FIG. 9).

As described above, since the intensity of interference color changes according to the gradation, also in an interference color reduction processing, it is desirable that the interference color reduction processing is selectively changed according to the gradation. The intensity of the interference color reduction processing is preferably changed according to the distance from the origin of the a* and b* of specular reflected light. As a method for changing the intensity of the interference color reduction processing, a method for controlling a degree of the concentration of dots in half-tone can be used.

A case where a dot-concentration type halftone is used selectively according to gradation is described in the following. The processing similar to those in the first embodiment is not described.

In the third embodiment, the binary digitization processing unit J004 in FIG. 2 generates 5-valued data P(x, y), and then generates binary image data B(x, y) from 5-valued data P(x, y). In generation of 5-valued data P(x, y), a well-known 5-value error diffusion is used. In generating binary data B(x, y) from 5-valued data (x, y), a density pattern method is used. In the density pattern method, a predetermined dot pattern is allocated to a specific gradation. In this embodiment, a case where an allocated dot pattern is changed according to a pixel position (x, y) is described in the following, but this embodiment is not limited to this example.

FIG. 12 illustrates dot patterns by way of an example. A dot pattern 50 is an example of a dot pattern corresponding to a case where a gradation level of gradation output is 0. Similarly, a dot pattern 51 corresponds to output gradation ¼, a dot pattern 52 corresponds to output gradation 2/4, a dot pattern 53 corresponds to output gradation ¾, and a dot pattern 54 corresponds to output gradation 1.

Squares illustrated in FIG. 12 correspond to output dot areas, black squares indicate areas where dots are recorded, and white squares indicate areas where dots are not recorded. The binary digitization processing unit J004 selects one of the dot patterns 50, 51, 52, 53, and 54 for 5-valued data P(x, y). When the dot pattern 51, 52, or 53 is selected, using pixel positions (x, y), the binary digitization processing unit J004 selects areas of 2*2 pixels of a selected dot pattern, and selects the dot patterns of the areas as output pixels. For example, if the number of horizontal pixels is designated as w and the number of vertical pixels is designated as h in the dot pattern 51, 52, or 53, 2*2 pixels specified by the following coordinates are selected as output dot patterns.

((2x) % w, (2y) % h)
((2x) % w+1, (2y) % h)
((2x) % w, (2y) % h+1)
((2x) % w+1, (2y) % h+1)
Where % designates modulo (surplus) arithmetic operation

In this embodiment, by selecting at least one pattern in which dots are concentrated as a dot pattern 51, 52, or 53, the dot concentration property is varied according to gradation. For example, a dot pattern 55 with high-degree dot concentration is used as a dot pattern corresponding to output gradation ¼. As dot patterns of different degrees of dot concentration, arbitrary dot patterns may be used. For example, a dot pattern, in which some dots are dispersed so as to be separate from output pixels, such as a dot pattern 56 may be used. Thus, it becomes possible to control dot concentration selected according to gradation.

As a method for generating dot patterns, a well-known dot-concentration type halftone method or a dither matrix generation method may be used. In this embodiment, 5-valued data P(x, y) is generated as intermediate data, but the number of gradation of intermediate data is not limited.

In this embodiment, the dot concentration property is controlled by combining the multi-value error diffusion method and the density pattern method, but another method may be used. For example, the dot concentration type error diffusion method discussed in Japanese Patent Application Laid-Open No. 2007-129446 or the dither matrix method may be used. Or, a modified version of these methods may be used.

“Spatially concentrated” in the above-described embodiment means both that a plurality of dots are concentrated in nearby positions on the paper and that a plurality of dots are formed superposed on top of each other. If it is necessary to differentiate them, the former is expressed as “clustering”, and the latter is expressed as “dot superposition” or “dot on dot”.

The present invention may be applied to a system including a plurality of devices (a host computer, an interface device, a reader, and a printer, for example), or to a stand alone device (a copy machine, a facsimile unit, for example). In the above-described embodiments, paper is used as a recording medium (printing medium), but recording media are not limited to paper. OHP film and CD-ROM label may also be used as recording media.

In these embodiments, description has been made of a printer as an example, but the present invention is not limited to printers and may be applied to copy machines, and toner may be used as a color material. The processes of the present invention can be obtained as software (program) via a network or in a computer-readable storage medium, and can be implemented by executing the software on a processing unit (CPU, processor) in a personal computer.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s).

For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2009-149165 filed Jun. 23, 2009 and No. 2009-280687 filed Dec. 10, 2009, which are hereby incorporated by reference herein in their entirety.

1. An image forming apparatus for forming an image by using a plurality of color materials including pigment as a color material, by performing recording scans with a recording head in a direction perpendicular to a conveyance direction of a recording medium to scan the same image area on the recording medium more than once, the recording head being fitted with recording-element columns as many as kinds of color materials, each recording-element column including a plurality of recording elements arranged in different direction to the conveyance direction of the recording medium, the image forming apparatus comprising:
an input unit configured to input image data representing an image;
a conversion unit configured to convert the image data into dot data representing an image by a plurality of dots; and
an allocation unit configured to allocate the dot data in each of the recording scans to the recording elements,
wherein the allocation unit performs the allocation in such a manner that the dots are concentrated in clusters of a predetermined size and at least one dot is superposed on top of another in the same image area.

2. The image forming apparatus according to claim 1, wherein the allocation unit performs the allocation to selectively allocate the recording elements to a plurality of dot data corresponding to a plurality of color materials used in printing equipment.

3. The image forming apparatus according to claim 1, wherein the allocation unit performs the allocation to the image data according to a set output mode of the image data.

4. The image forming apparatus according to claim 1, further comprising:
a quantization unit configured to quantize the image data while reducing gradation, wherein the quantization unit spatially concentrates signals after the quantization of the image data.

5. The image forming apparatus according to claim 4, wherein the quantization unit corrects quantization errors according to information about dots to be superposed by the allocation unit.

6. The image forming apparatus according to claim 4, wherein the quantization unit varies a degree of concentration of dot patterns according to values of pixels of the image data.

7. An image forming method for forming an image by using a plurality of color materials including pigment as a color material, by scanning and recording with a plurality of recording heads in a direction perpendicular to a conveyance direction of a recording medium to scan the same image areas on the recording medium more than once, the recording heads being fitted with recording-element columns as many as kinds of color materials, each recording-element column including a plurality of recording elements arranged in a different direction to a conveyance direction of a recording medium, the image forming method comprising:
inputting image data to display an image;
converting the image data into dot data representing an image by a plurality of dots; and
allocating the recording elements to the dot data in each of recording scans,
wherein in the allocation, the dots are concentrated in clusters of a predetermined size in the same image areas and at least one dot is superimposed on top of another in the same image areas.

8. A non-transitory computer-readable recording medium storing a program designed to make a computer control of an image forming apparatus for forming an image by using a plurality of color materials including pigment as a color material, by scanning with a plurality of recording heads in a direction perpendicular to a conveyance direction of a recording medium to scan the same image areas on the recording medium more than once, the recording heads being fitted with recording-element columns as many as kinds of color materials, each recording-element column including a plurality of recording elements arranged in a different direction to the conveyance direction of the recording medium, the program causing the computer to perform:
inputting image data to display an image;
converting the image data into dot data representing an image by a plurality of dots; and
allocating the recording elements to the dot data in each of recording scans,
wherein in the allocation, the program controls the computer to concentrate the dots in clusters of a predetermined size in the same image areas and superpose at least one dot on top of another.

9. (canceled)
